(19) United States
(12) Patent Application Publication
(10) Pub. No.: US 2026/0263919 A1
(43) Pub. Date: Sep. 10, 2026

(54) GAMEPAD AND GAME DEVICE

(71) Applicants: YUN XIE, Shanghai (CN); GENGSHEN PENG, Chongqing (CN); SHUYU HUANG, Fuzhou, Fujian (CN); XIANGYU HUANG, Maoming, Guangdong (CN)

(72) Inventors: YUN XIE, Shanghai (CN); GENGSHEN PENG, Chongqing (CN); SHUYU HUANG, Fuzhou, Fujian (CN); XIANGYU HUANG, Maoming, Guangdong (CN)

(21) Appl. No.: 19/555,789

(22) Filed: Mar. 3, 2026

(30) Foreign Application Priority Data
Mar. 5, 2025 (CN) 2025203788994

(51) Int. Cl. A63F 13/24

(52) U.S. Cl. CPC A63F 13/24

(57) ABSTRACT

The present disclosure provides a gamepad and a game device. The gamepad includes a body, a control assembly, and a back-key assembly. The body includes a front operation portion, and a rear operation portion. The front operation portion includes a left operation region and a right operation region, and the rear operation portion includes a left rear region and a right rear region, with the left rear region corresponding to the left operation region and the right rear region corresponding to the right operation region. The control assembly is disposed on the front operation portion and includes a first joystick element. The back-key assembly includes a first back-key group. The first joystick element is disposed in the left operation region and the corresponding first back-key group is disposed in the left rear region. The disclosed gamepad provides advantages such as grip comfort, operation convenience, expandability and customization.

### CROSS-REFERENCE TO RELATED APPLICATIONS

The application claims the priority to Chinese Patent Application No. 2025203788994, entitled “GAMEPAD AND GAME DEVICE”, and filed on Mar. 6, 2025, the entire contents of which is incorporated herein by reference.

### TECHNICAL FIELD

The present disclosure relates to the technical field of game device, and in particular, to a gamepad and a game device.

### BACKGROUND

With the continuous development of technology, users' requirements for high-quality game experiences are gradually increasing, and gamepads, game consoles, VR devices, and other game devices have become widely adopted by players. In particular, gamepads are favored for their control precision, ergonomic comfort, multiplayer capability, and functional versatility.

However, in related art, a gamepad, due to its established product definitions and structural limitations, does not fully utilize the ergonomic capability of the user's hand. For example, professional esports players often need to simultaneously and correctly actuate multiple buttons and joystick elements during intense competitive gameplay. To achieve this, they may habitually use grip techniques such as the “claw grip,” which can lead to repetitive-strain injuries such as tenosynovitis. Accordingly, improving the structural design of a gamepad to enhance its ergonomic comfort and control precision, and to meet the requirements for high-quality game experiences, has become an urgent technical problem to be solved.

### SUMMARY OF THE INVENTION

### The Present Disclosure Provides a Gamepad, Including:

a body, the body comprising a left grip portion, a right grip portion, a front operation portion, and a rear operation portion, the front operation portion comprising a left operation region and a right operation region, the rear operation portion comprising a left rear region and a right rear region, the left rear region corresponding to the left operation region, and the right rear region corresponding to the right operation region;
a control assembly, the control assembly disposed on the front operation portion, the control assembly comprising a first joystick element; and
a back-key assembly, the back-key assembly comprising a first back-key group, the first back-key group comprising at least three back keys, and a distance between any two of the back keys in the first back-key group being less than or equal to 25 mm;
wherein the first joystick element is disposed in the left operation region and the first back-key group is disposed in the left rear region correspondingly; or the first joystick element is disposed in the right operation region and the first back-key group is disposed in the right rear region correspondingly.

The present disclosure further provides a game device, including a game console and the gamepad provided by the embodiments of the present disclosure, the gamepad being communicatively connected to the game console.

### BRIEF DESCRIPTION OF THE DRAWINGS

In order to more clearly illustrate the technical solutions in the embodiments of the present disclosure, the following is a brief introduction to the drawings needed in the description of the embodiments. Obviously, the drawings in the following description are some embodiments of the present disclosure. For those of ordinary skill in the art, other drawings can be obtained based on these drawings without any creative effort.

FIG. 1 is a schematic structural diagram of a gamepad from a first viewing angle in an embodiment of the present disclosure.

FIG. 2 is a schematic structural diagram of the gamepad from a second viewing angle in an embodiment of the present disclosure.

FIG. 3 is a schematic structural diagram of the gamepad from a third viewing angle in an embodiment of the present disclosure.

FIG. 4 is a schematic structural diagram of the gamepad from a fourth viewing angle in an embodiment of the present disclosure.

FIG. 5 is a schematic structural diagram of a gamepad according to another embodiment of the present disclosure.

FIG. 6 is a schematic structural diagram of a gamepad according to another embodiment of the present disclosure.

FIG. 7 is a schematic structural diagram of a gamepad according to another embodiment of the present disclosure.

FIG. 8 is a schematic block diagram of a game device according to an embodiment of the present disclosure.

### LIST OF REFERENCE SIGNS IN EMBODIMENTS OF THE PRESENT DISCLOSURE

100, gamepad; 200, game device; 210, game console; 220, display apparatus; 10, body; 11, left grip portion; 111, side edge of the left grip portion; 12, right grip portion; 121, side edge of the right grip portion; 13, front operation portion; 131, left operation region; 132, right operation region; 14, rear operation portion; 141, left rear region; 142, right rear region;
20, control assembly; 21, first joystick element; 22, front single-key button;
30, back-key assembly; 31, first back-key group; 32, second back-key group; 33, back key; 331, monolithic back key; 332, integrated key; 34, raised structure; 35, macro key;
40, shoulder key.

### DETAILED DESCRIPTION OF EMBODIMENTS

The technical solutions in the embodiments of the present disclosure will be clearly and completely described below with reference to the accompanying drawings in the embodiments of the present disclosure. Obviously, the described embodiments are a part of the embodiments of the present disclosure, but not all of them. Based on the embodiments in the present disclosure, all other embodiments obtained by those of ordinary skill in the art without creative effort shall fall within the protection scope of the present disclosure.

The following describes in detail some embodiments of the present disclosure with reference to the accompanying drawings. The embodiments and features in the embodiments may be combined with each other without conflict.

It should be understood that all directional indications (such as up, down, left, right, front, rear, etc.) in the embodiments of the present disclosure are provided merely to describe the relative positional relationships and movements of the components under a particular orientation. If that orientation changes, the corresponding directional indications should be interpreted accordingly.

It should also be understood that when an element is described as being “fixed to” or “disposed on” another element, it may be directly on the other element or may be indirectly on the other element through one or more intermediate elements. Likewise, when an element is described as being “connected to” another element, it may be directly connected or indirectly connected through one or more intermediate elements.

Therefore, the terms should not be understood as limitations on the present disclosure. Furthermore, terms “first” and “second” are used for descriptive purposes and should not be understood as indicating or implying relative importance or implying the number of the technical features indicated. Thus, features defined with “first” or “second” may explicitly or implicitly include one or more of the described features.

It should be further understood that term “and/or” as used in the specification and the appended claims of the present disclosure refers to any combination and all possible combinations of one or more of associated listed items, and includes such combinations.

With the continuous advancement of the game industry, users' pursuit of high-quality game experiences continues to drive game-device manufacturers to improve products and innovate technologies. As the game industry and general living standards develop, many players choose to use gamepads, game consoles, VR devices, and other game devices to obtain higher-quality game experiences. In particular, gamepads are widely favored for their control precision, ergonomic comfort, multiplayer capability, and functional versatility.

However, traditional gamepads, due to their established product definitions and structural designs, still have room for improvement in terms of control precision and ergonomic comfort. For example, because of the specific structural layout of conventional gamepads, the ways in which the device can be gripped are relatively limited. In particular, the left and right joystick elements, the four directional buttons, and the four action buttons (i.e., A/B/X/Y or o/A/u/x) are generally operated only by the player's left and right thumbs. As a result, a player can typically actuate at most two buttons or joystick elements precisely at the same time, which restricts in-game actions and can no longer meet the increasingly complex gameplay requirements of modern games.

To address this, some manufacturers have begun adding mapping paddles (back keys) on the rear side of the gamepad to reduce the workload of the thumbs. Most gamepads with mapping functionality use a design with four back keys, with two back keys on each side. However, players must make trade-offs: only the most frequently used four front-side buttons can be mapped to the back keys, and players must configure different mappings for different games, requiring time and practice to build operational proficiency and muscle memory. Because the number of back keys is insufficient to map all commonly used front-side buttons, and because the arrangement of the back keys differs from that of the front-side buttons, the player's thumbs are not fully freed from the front-side buttons. In practice, players still often move their thumbs away from the joystick elements to press front-side buttons, which imposes a significant learning burden for most users.

Due to these limitations, some professional esports players do not use traditional gamepads with mapping paddles in competition. Instead, they adopt the “claw grip,” in which the gamepad is held primarily by the middle, ring, and little fingers, while the index fingers and thumbs are positioned on the front-side controls to enable simultaneous and precise actuation of more buttons or joystick elements. However, this grip technique can lead to repetitive-strain injuries such as tenosynovitis.

Accordingly, there is a need to improve the structural design and button layout of the gamepad. In some embodiments, the back keys may be arranged in a quantity and sequence similar to those of the front-side buttons. Such improvements can reduce the operational burden on the player's thumbs, significantly lower the learning cost, and enhance the overall gamepad-operation experience. As a result, the gamepad can better satisfy users' demand for comfortable, precise, and high-quality game experiences.

Some embodiments of the present disclosure provide a gamepad and a game device, the gamepad includes a first back-key group corresponding to the first joystick element on the front side. The first back-key group may include at least three back keys, with the distance between any two back keys being less than or equal to 25 mm. This allows a player, while gripping the gamepad, to operate the joystick with the thumb positioned on the front side of the gamepad and simultaneously actuate multiple buttons with the fingers of the same hand positioned on the rear side of the gamepad. As a result, operations such as “jump-aiming,” “jump-scoping,” and “moving while performing complex skills” can be achieved, thereby enhancing control precision and ergonomic responsiveness, improving overall control sensitivity and comfort and delivering a richer control experience on the basis of a natural and comfortable grip, and improving the win rate for esports players.

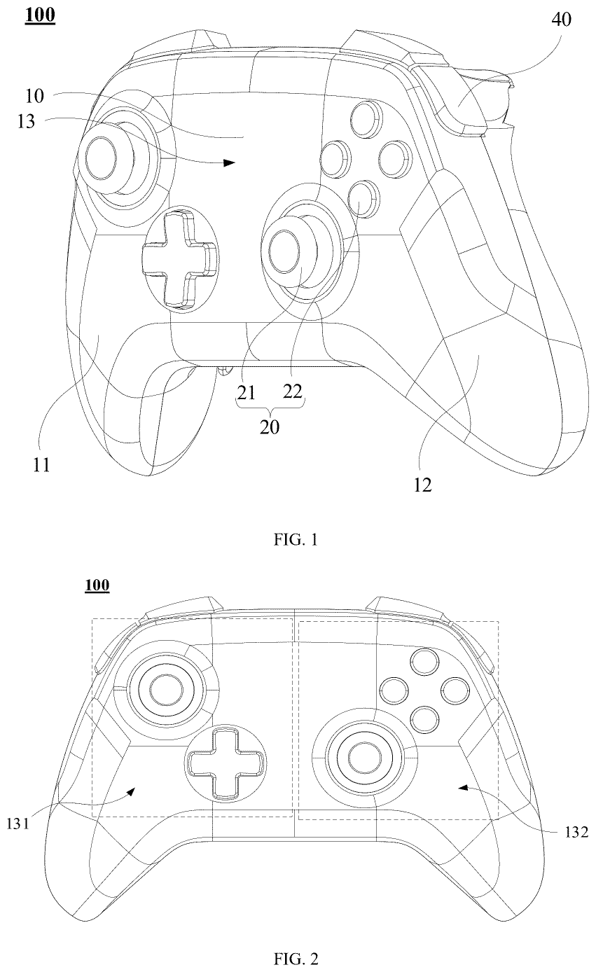

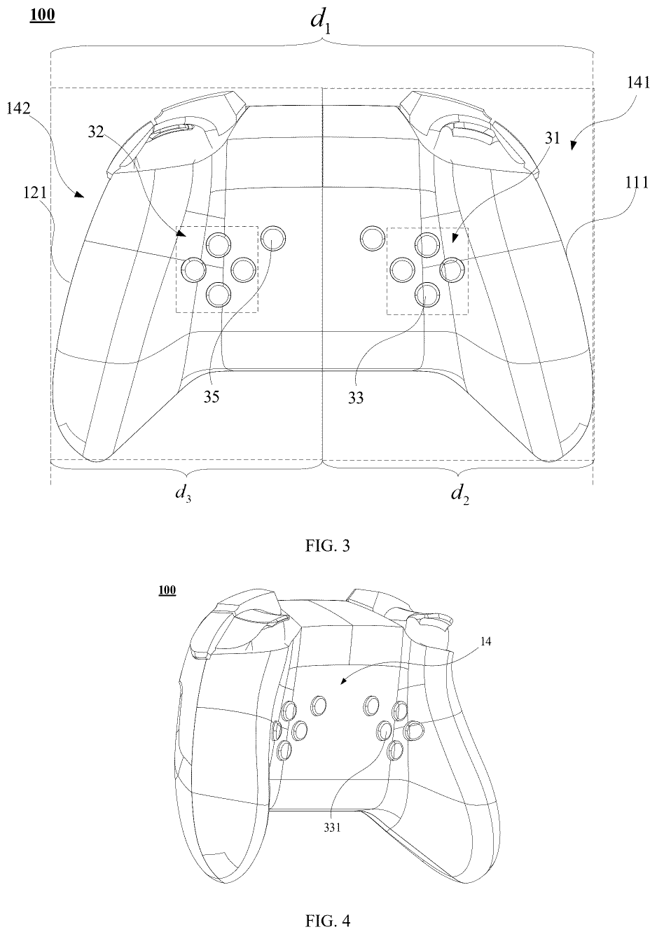

With reference to FIG. 1, FIG. 2, and FIG. 3, FIG. 1 is a schematic perspective view of a gamepad from a first viewing angle in an embodiment of the present disclosure. FIG. 2 is a schematic perspective view of the gamepad from a second viewing angle in an embodiment of the present disclosure. FIG. 3 is a schematic perspective view of the gamepad from a third viewing angle in an embodiment of the present disclosure. FIG. 4 is a schematic perspective view of the gamepad from a fourth viewing angle in an embodiment of the present disclosure.

As shown in FIG. 1, FIG. 2, FIG. 3, and FIG. 4, an embodiment of the present disclosure provides a gamepad 100. The gamepad 100 may include a body 10, a control assembly 20, and a back-key assembly 30. The body 10 may include a left grip portion 11, a right grip portion 12, a front operation portion 13, and a rear operation portion 14. The front operation portion 13 may include a left operation region 131 and a right operation region 132, and the rear operation portion 14 may include a left rear region 141 and a right rear region 142. The left rear region 141 corresponds to the left operation region 131, and the right rear region 142 corresponds to the right operation region 132.

In some embodiments, the control assembly 20 may be disposed on the front operation portion 13 and may include a first joystick element 21. The back-key assembly 30 may include a first back-key group 31, and the first back-key group 31 may include at least three back keys 33. Because the back keys are operated by the user's fingers positioned on the rear operation portion 14 of the gamepad 100, the distance between any two back keys 33 in the first back-key group 31 may be less than or equal to 25 mm.

In some embodiments, the distance between any two back keys 33 in the first back-key group 31 may be less than or equal to 15 mm.

In some embodiments, the distance between any two back keys 33 in the first back-key group 31 may be less than or equal to 10 mm.

With this arrangement, the user can perform a wide range of operations by actuating the first back-key group 31 together with the joystick element 40. This enables actions such as “jump-aiming,” “jump-scoping,” and “moving while casting complex skills” with one hand operating both a joystick element and a back-key group on the same side. When the user wishes to operate the front-side buttons and the joystick on the same side, there is no longer a need to adopt grip techniques such as the “claw grip,” which are detrimental to hand health. As a result, the player's gamepad-operation experience is improved, better addressing users' expectations for flexible, comfortable, precise, and ergonomically healthy high-quality game experiences, while providing more precise, responsive, versatile, and comfortable control and improving the win rate for esports players.

It can be understood that, considering differences in hand geometry among users, how to configure structural design factors such as the position, layout, and shape of the first back-key group 31 so as to improve the player's gamepad-operation experience and better satisfy the demand for comfort, precision, flexibility, and other high-quality gaming characteristics has become an issue that warrants further consideration.

In some embodiments, the first back-key group 31 may be disposed at a position of the rear operation portion 14 corresponding to the first joystick element 21, so that the user can operate the first back-key group 31 and the first joystick element 21 with the same hand.

In some embodiments, the left rear region 141 may be defined by the following relationship:

$${d}_{2} \leq \frac{1}{2} {d}_{1}$$

where d₁ is a maximum length of the gamepad 100 from a left side of the left grip portion 11 to a right side of the right grip portion 12, and d₂ is a length from the left rear region 141 to the left side of the left grip portion 11. And/or, the right rear region 142 may be defined by the following relationship:

$${d}_{3} \leq \frac{1}{2} {d}_{1}$$

where d₁ is a maximum length of the gamepad 100 from a left side of the left grip portion 11 to a right side of the right grip portion 12, and d₃ is a length from the right rear region 142 to the right side of the right grip portion 12. And/or, a shortest distance between a center position of the first back-key group 31 and a side edge of the corresponding left grip portion 11 or the corresponding right grip portion 12 is from 1 mm to 75 mm.

In some embodiments, the shortest distance between a center position of the first back-key group 31 and the side edge 111 of the corresponding left grip portion 11 or the side edge 121 of the corresponding right grip portion 12 may be from 20 mm to 70 mm.

In some embodiments, the shortest distance between a center position of the first back-key group 31 and the side edge 111 of the corresponding left grip portion 11 or the side edge 121 of the corresponding right grip portion 12 may be from 40 mm to 60 mm.

The inclusion of the first back-key group 31 on the rear side of the gamepad 100 alters the structural design of traditional gamepads. As a result, conventional gripping methods and operational behaviors also change. To reduce the burden on users' learning, memorizing, and adapting for the new product, to improve the player's eye-hand reaction speed, and to facilitate the muscle-memory formation, at least one back key 33 in the first back-key group 31 may have a functional, structural, or actuation-method mapping relationship with at least one key on the front side of the gamepad 100.

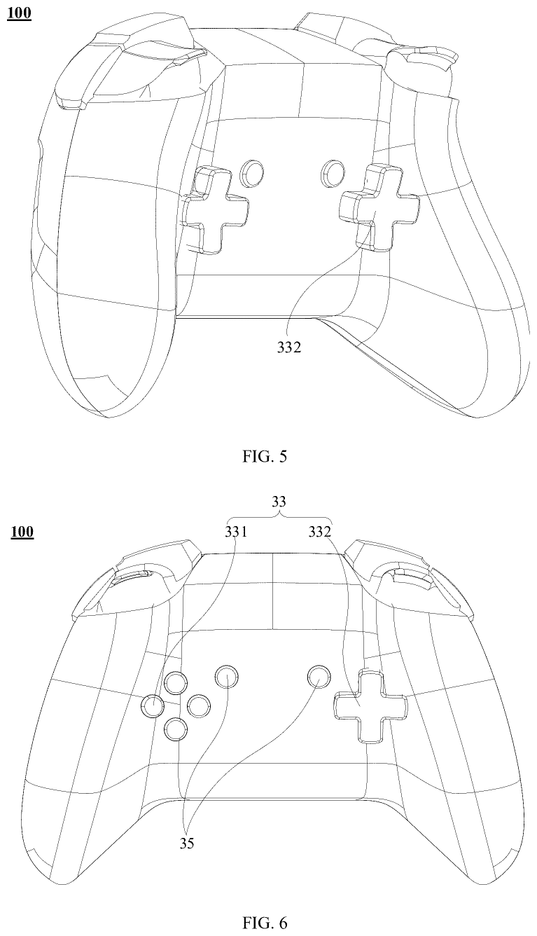

Referring also to FIG. 5, FIG. 5 is a perspective structural schematic diagram of a gamepad according to another embodiment of the present disclosure. As shown in FIG. 5, in some embodiments, the first back-key group 31 may include at least four monolithic back keys 331. The four monolithic back keys 331 may be arranged in a quadrilateral layout such as a diamond-shaped four-corner layout, a rectangular four-corner layout, or a trapezoidal four-corner layout. And/or, the first back-key group 31 may include an integrated key 332 having a square, cross-shaped, triangular, or circular configuration.

In some embodiments, the rear operation portion 14 may also be provided with a macro key 35. The macro key 35 may be configured as various types such as a programming key, a menu key, or a combo-skill key, and may take the form of a paddle, joystick, switch, or other structure, without being specifically limited herein.

In some embodiments, the control assembly 20 may further include a first button group, and a functional mapping relationship may be established between the first button group and the first back-key group 31. With such an arrangement, the player can determine the layout and/or functions of the back keys 33 in the first back-key group 31 on the rear side of the gamepad 100 by looking at the first button group or by relying on the operating habits associated with the first button group on the front side of the gamepad 100, thereby improving reaction speed and enhancing the overall game-control experience.

In some embodiments, the first button group may include at least four front single-key buttons 22, and the first back-key group 31 may include at least four monolithic back keys 331. The layout arrangement of the four front single-key buttons 22 may correspond to the layout arrangement of the four monolithic back keys 331.

It can be understood that, because players have different operating preferences and different games have different operational requirements, players may need to customize the specific forms of the back keys-such as monolithic structures versus integrated structures, or cross-shaped configurations versus diamond-shaped configurations—to make the gamepad 100 more suitable for their use. Accordingly, the structures of some monolithic back keys 331 may be configured to fit standardized keycaps, such as cross-shaped keycaps or square keycaps, allowing players to select preferred kits at a lower cost.

In some embodiments, the first back-key group 31 may include at least three monolithic back keys 331, and the at least three monolithic back keys 331 may be compatible with different forms of common keycaps, such as square, cross-shaped keycaps, triangular keycaps, or circular keycaps, to form an integrated key 332.

It can be understood that, to further improve operating efficiency and operating experience, the back-key assembly 30 may also include a second back-key group 32. In some embodiments, the first back-key group 31 may be disposed in the left back region 141, and the second back-key group 32 may be disposed in the right back region 142 correspondingly; or the first back-key group 31 may be disposed in the right back region 142, and the second back-key group 32 may be disposed in the left back region 141 correspondingly.

In some embodiments, the second back-key group 32 may correspond to the first back-key group 31 with respect to the number, form, shape, or layout of the back keys 33 in each group. The term ‘form’ may include monolithic versus integrated keys, specific mechanical implementations of the keys, or detachable versus non-detachable key structures. Specific mechanical implementations may include paddle-type keys, dome-switch keys, or keyboard-switch mechanisms. The term ‘shape’ may include key-surface width, key-surface shape, or key-surface texture. With such an arrangement, users can more easily distinguish among different back keys 33, thereby reducing the burden on learning, memorization, and adaptation and facilitating the formation of operational muscle memory.

Referring also to FIG. 6, FIG. 6 shows a schematic structural diagram of a gamepad according to another embodiment of the present disclosure. In some embodiments, depending on actual needs such as user preferences or game types, the number, form, shape, or layout arrangement of the back keys 33 in the second back-key group 32 may differ from, or may not completely correspond to, those of the first back-key group 31. In some embodiments, the first back-key group 31 may be a combination of monolithic back keys 331, while the second back-key group 32 may include at least one integrated key 332.

It can be understood that users have different finger thicknesses and finger-pad widths. An excessively wide key-surface width may make it difficult for users to quickly switch between keys, whereas an excessively narrow key-surface width may make it difficult to design appropriate tactile feedback and may increase the risk of accidental actuation. In some embodiments, a minimum key-surface width of at least one back key 33 may be from 1 mm to 40 mm. In some embodiments, a minimum key-surface width of at least one back key 33 may be from 1 mm to 20 mm. In some embodiments, a minimum key-surface width of at least one back key 33 may be from 1 mm to 12 mm. In some embodiments, a minimum key-surface width of at least one back key 33 may be from 6 mm to 12 mm.

It can also be understood that a pressing feel of the back keys may differ from the pressing feel of the front-side buttons. The pressing feel may be improved by setting a trigger travel or a total key travel, thereby enhancing the gameplay experience. In some embodiments, the trigger travel or total key travel of at least one back key 33 may be from 0.1 mm to 20 mm. In some embodiments, a trigger travel or total key travel of at least one back key 33 may be from 0.1 mm to 10 mm. In some embodiments, a trigger travel or total key travel of at least one back key 33 may be from 0.1 mm to 4 mm.

In some embodiments, the pressing feel may also be improved by providing a pressing-force range, thereby enhancing the gameplay experience. In some embodiments, the pressing-force range of at least one back key may be from 1 gf to 300 gf. In some embodiments, the pressing-force range of at least one back key may be from 1 gf to 250 gf. In some embodiments, the pressing-force range of at least one back key may be from 1 gf to 160 gf. In some embodiments, the pressing-force range of at least one back key may be from 65 gf to 120 gf.

Because the back keys are located in an out-of-sight region when a user holds the gamepad 100, how to avoid accidental actuations, reduce the difficulty of perceiving the back keys, and thereby improve operational accuracy and gameplay experience becomes an issue to be addressed.

In some embodiments, a central region of the first back-key group 31 may be a smooth surface; and/or a central region of the first back-key group 31 may be provided with a texture; and/or a key surface of at least one back key 33 may be provided with a texture; and/or a shape of a key surface of at least one back key 33 may be different from a shape of a key surface of at least one other back key 33. With such an arrangement, the distinguishability among different back keys 33 can be enhanced, making it easier for users to differentiate the back keys 33. In addition, because the central region of the first back-key group 31 is often located between multiple back keys 33, the user can more easily distinguish the central region from the back keys 33, thereby quickly locating the positions of the back keys 33, reducing accidental actuations, and rapidly identifying the target back key 33 during operation, thereby achieving a highly responsive and precise gameplay experience.

It can be understood that the back keys 33 are not limited to press-type keys. In some embodiments, the rear operation portion 14 may be provided with a touchpad, and at least one back key 33 may be a virtual key of the touchpad; and/or the back-key assembly 30 may include a touch sensor configured to implement touch-based back-key operations; and/or at least one back key 33 may be provided with a pressure sensor.

In some embodiments, the gamepad 100 may further include at least one shoulder key 40. The shoulder key 40 is disposed on the same side as the first back-key group 31, and a center position of the first back-key group 31 is located at a position of the rear operation portion 14 reachable by a fingertip of a middle finger or ring finger of a user's hand when a thumb of the hand contacts the first joystick element 21 and an index finger of the hand contacts the shoulder key 40. With such an arrangement, comfortable operation of the first back-key group 31 can be maintained while the shoulder key 40 is appropriately positioned, thereby further unlocking the full ergonomic capability of the user's hand and improving user control and gameplay experience.

In some embodiments, because the rear-side operation behavior and perception behavior of the gamepad 100 differ from those of the front side, and because users with different hand sizes may perceive key locations differently, the back-key assembly 30 may further implement pose adjustment through a base in order to reduce adaptation difficulty, accommodate different hand sizes, and improve operational comfort. In some embodiments, the back-key assembly 30 may further include a base, the first back-key group 31 may be disposed on the base, and the base may be adjustably mounted to the rear operation portion 14 such that the first back-key group 31 is translatable and/or rotatable relative to the rear operation portion 14.

It can be understood that, for different games, a user may temporarily remove or replace different types of back keys 33 to avoid accidental actuations or to improve gameplay experience. The back keys 33 may be installed on the rear side of the gamepad as a group, or may be individually mounted as separate back keys 33. In some embodiments, at least one back key 33 may be detachably connected to the gamepad 100. The back key 33 may be magnetically connected to the gamepad 100 and/or connected by a latch mechanism.

It can also be understood that, in order to provide a better grip experience, the left grip portion 11 and the right grip portion 12 may be arranged symmetrically about an axis of the body 10. In some embodiments, at least a portion of a left-side edge 111 of the left grip portion 11 may be inclined relative to the axis of the body 10, and/or at least a portion of a right-side edge 121 of the right grip portion 12 may be inclined relative to the axis of the body 10, such that when the user grips the corresponding grip portion of the gamepad 100 and operates the back key 33 with the middle finger, the design of the grip portion ensures that the maximum spreading angle between the ring finger and middle finger is 0°-60°.

In further embodiments, a grip portion may be shaped such that, when the user grips the corresponding grip portion of the gamepad 100 and operates the back key 33 with a middle finger, the design of the grip portion ensures that a maximum spreading angle between the ring finger and the middle finger of the same hand is within a range of 0° to 50°.

In further embodiments, a grip portion may be shaped such that, when the user grips the corresponding grip portion of the gamepad 100 and operates the back key 33 with a middle finger, the design of the grip portion ensures that a maximum spreading angle between the ring finger and the middle finger of the same hand is within a range of 0° to 40°.

It can be understood that, to facilitate storage or to enable combined use with devices such as mobile phones, at least a portion of the left grip portion 11, the right grip portion 12, the front operation portion 13, or the rear operation portion 14 may be detachably mounted to the body 10.

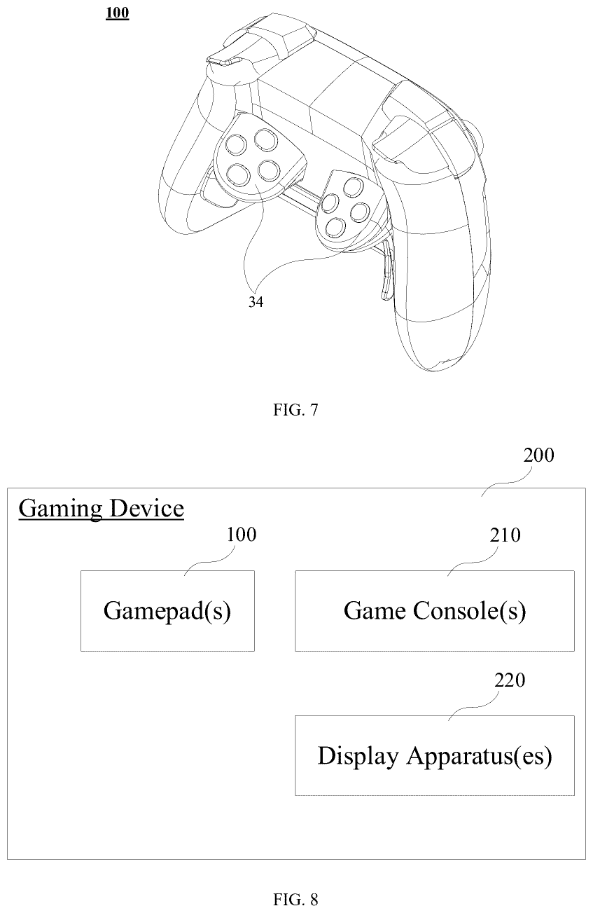

Referring to FIG. 7, FIG. 7 shows a schematic structural diagram of a gamepad according to another embodiment of the present disclosure. As shown in FIG. 7, the rear operation portion 14 may further be provided with a raised structure 34. The raised structure 34 may include at least three back keys 33. The raised structure 34 may cooperate with the first back-key group 31, and may be disposed on the rear operation portion 14. With such an arrangement, the raised structure 34 can better conform to the posture of a user's palm when gripping the gamepad 100, thereby providing improved ergonomic performance and delivering a more precise, responsive, and comfortable control experience.

The present disclosure further provides a game device 200, which may include the gamepad 100 according to any of the embodiments described herein. In some embodiments, the game device may include a game console and the gamepad 100 according to any of the embodiments of the present disclosure, and the gamepad 100 may be communicatively connected to the game console.

Referring to FIG. 8, FIG. 8 is a schematic block diagram of a game device according to an embodiment of the present disclosure. As shown in FIG. 8, in some embodiments, the game device 200 may include a display apparatus 220, a game console 210, and at least one gamepad 100. In further embodiments, the game device 200 may include multiple gamepads 100, or a single gamepad 100 may be split into two sub-controllers for two-player operation. The game device 200 may include the game console 210 and at least one gamepad 100, without including the display apparatus 220. With such configurations, the game device 200 can accommodate multiplayer family-gaming scenarios, including team matches, online matches, or multi-player competitive modes. Moreover, due to the provision of the back keys 33, when one gamepad 100 is split into two sub-controllers, the ergonomic potential of the back keys 33 can still be fully utilized by each sub-controller, thereby maintaining a certain level of control richness and enhancing the user's gameplay experience.

To the extent not mutually inconsistent, those skilled in the art may combine and integrate the different embodiments or examples described in the present disclosure, as well as features of the different embodiments or examples.

The above descriptions are specific embodiments of the present disclosure, but the protection scope of the present disclosure is not limited thereto. Any person skilled in the art can easily think of various equivalent modifications or substitutions within the technical scope disclosed in the present disclosure, and these modifications or substitutions shall fall within the protection scope of the present disclosure. Therefore, the protection scope of the present disclosure shall be subject to the protection scope of the claims.

What is claimed is:

1. A gamepad, comprising:
a body, the body comprising a left grip portion, a right grip portion, a front operation portion, and a rear operation portion, the front operation portion comprising a left operation region and a right operation region, the rear operation portion comprising a left rear region and a right rear region, the left rear region corresponding to the left operation region, and the right rear region corresponding to the right operation region;
a control assembly, the control assembly disposed on the front operation portion, the control assembly comprising a first joystick element; and
a back-key assembly, the back-key assembly comprising a first back-key group, the first back-key group comprising at least three back keys, and a distance between any two of the back keys in the first back-key group being less than or equal to 25 mm;
wherein the first joystick element is disposed in the left operation region and the first back-key group is disposed in the left rear region correspondingly; or the first joystick element is disposed in the right operation region and the first back-key group is disposed in the right rear region correspondingly.

2. The gamepad of claim 1, wherein the left rear region is defined by the following relationship:
$${d}_{2} \leq \frac{1}{2} {d}_{1}$$
where d₁ is a maximum length of the gamepad from a left side of the left grip portion to a right side of the right grip portion, and d₂ is a length from the left rear region to the left side of the left grip portion; and/or
the right rear region is defined by the following relationship:
$${d}_{3} \leq \frac{1}{2} {d}_{1}$$
where d₁ is a maximum length of the gamepad from a left side of the left grip portion to a right side of the right grip portion, and d₃ is a length from the right rear region to the right side of the right grip portion; and/or
a shortest distance between a center position of the first back-key group and a side edge of the corresponding left grip portion or right grip portion is from 1 mm to 75 mm.

3. The gamepad of claim 1, wherein the first back-key group is disposed at a position of the rear operation portion corresponding to the first joystick element, such that a user is capable of operating the first back-key group via a hand while the first joystick element is operated via the same hand.

4. The gamepad of claim 1, wherein the first back-key group comprises at least four monolithic back keys, and four of the monolithic back keys are respectively positioned at four corners of a quadrilateral arrangement.

5. The gamepad of claim 1, wherein the first back-key group comprises an integrated key.

6. The gamepad of claim 5, wherein the first back-key group comprises at least three monolithic back keys, and the at least three monolithic back keys are compatible with a common keycap to form the integrated key.

7. The gamepad of claim 1, wherein the control assembly comprises a first front-key group, and a functional mapping relationship exists between the first front-key group and the first back-key group.

8. The gamepad of claim 7, wherein the first front-key group comprises at least four front single-key buttons, and the first back-key group comprises at least four monolithic back keys, and a layout arrangement of the four front single-key buttons corresponds to a layout arrangement of the four monolithic back keys.

9. The gamepad of claim 1, wherein the back-key assembly further comprises a second back-key group;
wherein the first back-key group is disposed in the left rear region and the second back-key group is disposed in the right rear region correspondingly; or wherein the first back-key group is disposed in the right rear region and the second back-key group is disposed in the left rear region correspondingly.

10. The gamepad of claim 1, wherein a minimum key-surface width of at least one back key is from 1 mm to 40 mm; or wherein a distance between any two back keys in the first back-key group is less than or equal to 15 mm.

11. The gamepad of claim 10, wherein a minimum key-surface width of at least one back key is from 1 mm to 20 mm.

12. The gamepad of claim 11, wherein a minimum key-surface width of at least one back key is from 1 mm to 12 mm.

13. The gamepad of claim 12, wherein a minimum key-surface width of at least one back key is from 6 mm to 12 mm.

14. The gamepad of claim 1, wherein a trigger key travel or total key travel of at least one back key is from 0.1 mm to 20 mm.

15. The gamepad of claim 1, wherein a shortest distance between a center position of the first back-key group and a side edge of the corresponding left grip portion or right grip portion is from 20 mm to 70 mm.

16. The gamepad of claim 15, wherein a shortest distance between a center position of the first back-key group and a side edge of the corresponding left grip portion or right grip portion is from 40 mm to 60 mm.

17. The gamepad of claim 1, wherein the rear operation portion is provided with a touch panel, and at least one back key is a virtual key of the touch panel; or the back-key assembly comprises a touch sensor configured to implement touch operation of the back key; or at least one back key is provided with a pressure sensor.

18. The gamepad of claim 1, wherein the rear operation portion is further provided with a raised structure, the raised structure comprising at least three back keys, and the raised structure is configured to cooperate with the first back-key group and is disposed on the rear operation portion.

19. The gamepad of claim 1, wherein the left grip portion and the right grip portion are disposed opposite each other about an axis of the body;
wherein at least a portion of a left side edge of the left grip portion is inclined with respect to the axis of the body, or at least a portion of a right side edge of the right grip portion is inclined with respect to the axis of the body, such that when a user grips the corresponding grip portion and operates a back key with a middle finger, a maximum spreading angle between the ring finger and middle finger is from 0° to 60°.

20. The gamepad of claim 19, wherein a grip portion may be shaped such that when a user grips the corresponding grip portion and operates a back key with a middle finger, a maximum spreading angle between the ring finger and middle finger is from 0° to 40°.
